(19) United States
(12) Patent Application Publication
(10) Pub. No.: US 2006/0072065 A1
(43) Pub. Date: Apr. 6, 2006

(54) Eyecup for glasses

(76) Inventors: Ernest R Fernandez, San Jose, CA (US); Aaron M Markovitz, Denver, CO (US)

Correspondence Address: Stroock & Stroock & Lavan, 180 Maiden Lane, New York, NY, 10038, US

(21) Appl. No.: 10/529,973

(22) PCT Filed: Sep. 30, 2003
(86) PCT No.: PCT/US03/31084

§ 371 Date: Mar. 31, 2005

Related U.S. Application Data
(60) Provisional application No. 60/415,483, filed on Oct. 1, 2002.

(51) Int. Cl. G02C 5/00

(52) U.S. Cl. 351/41

(57) ABSTRACT

An eyecup for glasses designed to substantially fit against the face of the wearer. The eyecup may also comprise a lens therein.

### CROSS REFERENCE TO RELATED APPLICATIONS

The present application claims the benefit of U.S. Provisional Patent Application Ser. No. 60/415,483, filed on Oct. 1, 2002, which is incorporated herein by reference in its entirety.

### FIELD OF THE INVENTION

The present invention relates to an eyecup for eyewear, and in particular, relates to a removable eyecup for use with sunglasses.

### BACKGROUND OF THE INVENTION

Panoptx, Inc., the assignee of the present invention, is a market leader in the development of windless eyewear systems and products. The inventors of the present invention have determined that the presently available windless eyewear products do not make adequate contact with the wearer's face around the eyes, which hinders the eyewear's performance particularly in certain high wind applications. The inadequate contact also tends to render the prior art eyewear uncomfortable to wear, particularly for extended periods of time. The inventors of the present invention have also determined that the design and construction of the presently available windless eyewear products does not easily enable the adaptability or customization required in the windless eyewear market today.

Accordingly, the full range of features and benefits which could be provided by windless eyewear are not being realized in the prior art.

### SUMMARY OF THE INVENTION

The present invention relates to an improved eyecup for eyewear, and in particular, for sunglasses. The eyecup can be both removable from the frames of the sunglasses, or in an alternative embodiment, can be non-removable, or fixed, to the frame of the sunglasses.

In one aspect of the present invention, the rear surface of the eyecup is specially designed and constructed so as to enable the eyecup to substantially contact the entire area around the wearer's eyes by following the contour of the face more closely than the prior art designs. Such a feature can provide for increased performance of the eyewear for many applications, including, in particular, during high wind activities such as skiing and motorcycling. Such a feature also aids in comfort.

In another aspect of the present invention, the eyecup comprises a lens mounted or otherwise installed therein. A sealing gasket can be provided between the additional lens on the eyecup and the lens on the frame of the sunglass. Including a lens within the eyecup itself provides for increased optimization or customization of a windless eyewear product. For example, the lens within the eyecup can provide the ability to enhance the anti-fogging capabilities of the eyewear. Having a lens within the eyecup can also provide the ability to mount a prescription lens therein.

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims.

### BRIEF DESCRIPTION OF THE DRAWINGS

In the drawing figures, which are not to scale, and which are merely illustrative, and wherein like reference characters denote similar elements throughout the several views:

FIG. 1 is a perspective view of an eyeglass frame having an eyecup installed thereon, the eyecup being constructed in accordance with one aspect of the present invention;

FIG. 2 is a perspective view of the eyecup of FIG. 1 with the frames of the glasses shown in broken lines;

FIG. 3 is a cross sectional view of the eyecup of FIG. 2;

FIG. 4 is a perspective view of a pair of frames having an eyecup installed thereon, the eyecup being constructed in accordance with a second aspect of the present invention, with a ram air vent shown through the front face of the frame;

FIG. 5 is a perspective view of the eyecup depicted in FIG. 4, the eyecup having a channel formed therein which aligns with the ram air vent shown in FIG. 4, the eyecup also having a lens installed therein;

FIG. 6 is a perspective view of the eyecup of FIG. 5, the eyecup having tabs on each end for maintaining the removable eyecup in an eyeglass frame;

FIGS. 7, 8 and 9 are cross sectional views of the frame and eyecups of the present invention;

FIG. 10 is a perspective view of an eyecup of the present invention depicting a removable lens installed in the eyecup;

FIG. 11 is a perspective view of the removable lens of the eyecup depicted in FIG. 10;

FIG. 12 is a perspective view f an eyecup of the present invention without a ram air vent channel and without a lens installed therein; and

FIG. 13 is a rear view of the eyecup depicted in FIG. 12.

### DETAILED DESCRIPTION OF THE PRESENTLY PREFERRED EMBODIMENTS

The present invention relates to an improved eyecup for eyewear, and in particular, for sunglasses.

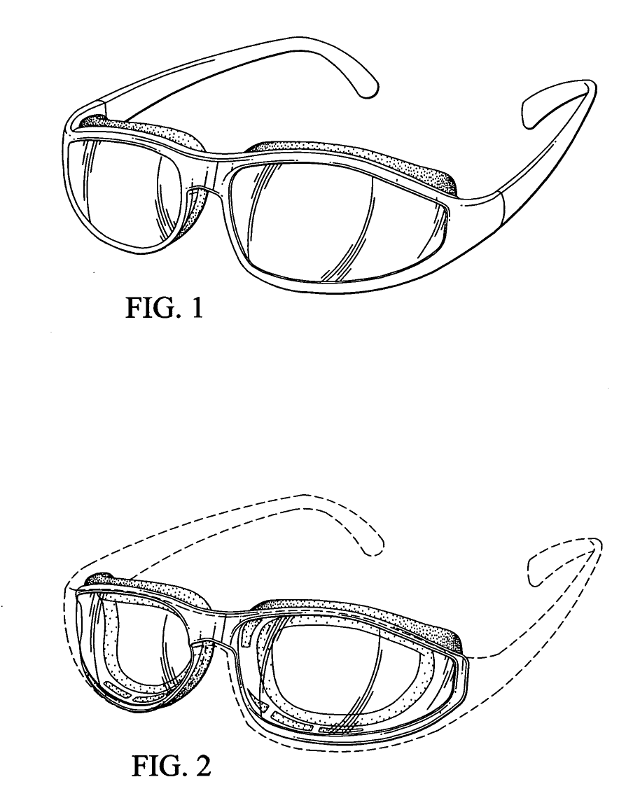

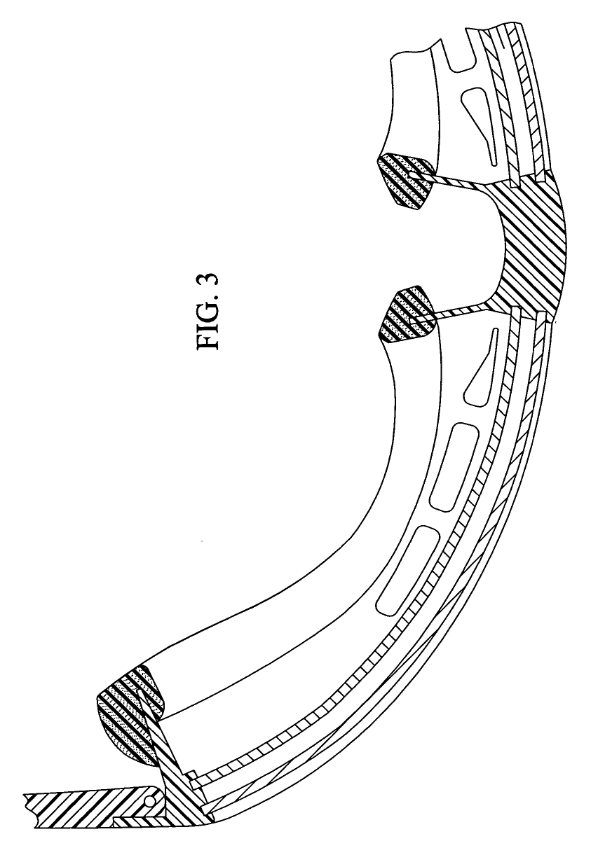

FIGS. 1-3 depict an eyecup in accordance with one aspect of the present invention. The eyecup includes a front surface that is designed to mate with the frame of a pair of lenses, such as for example, sunglass lenses. The eyecup can be either fixed to the frames, or removable. The eyecup also comprises a rear surface that is shaped to fit snuggly around the eyes of a wearer. In a preferred embodiment, the rear surface of the eyecup has foam installed thereon. Such foam can be, for example, an open cell air permeable foam or a closed cell foam. The rear surface may also be coated with a semi-rigid material such as silicone, etc. for providing the seal against the wearer's face. The foam can either be formed as two separate pieces, one around each eye aperture, or can be formed of one piece (not shown).

The inventors of the present invention have determined that the back or rear side of prior art lenses may not make full contact with the wearer's face around the eyes. Accordingly, the shape of the rear surface of the eyecup of the present invention has been accurately and specifically designed so as to enhance the contact with the wearer's face. In a preferred embodiment, the rear surface of the eyecup of the present invention has been accurately and specifically designed so as to substantially contact the face of the wearer proximate the eyes. In particular, the shape has been designed so as to contact the area of the face having substantial bone structure, as opposed to the non-bone areas of the face. In a preferred embodiment, the shape of the rear surface of the eyecup of the present invention has been designed so as to closely fit the face of the majority of adult Caucasian males. Further, in a preferred embodiment, the rear side of the eyecup is covered in a foam material to further enhance the fit and comfort of the eyewear.

Various venting apertures are formed between the front and rear surfaces of the eyecup to provide venting. In a preferred embodiment, the venting apertures are provided with a foam material so as to provide filtered venting. In a preferred embodiment, the foam material covers one or more sides of the venting apertures.

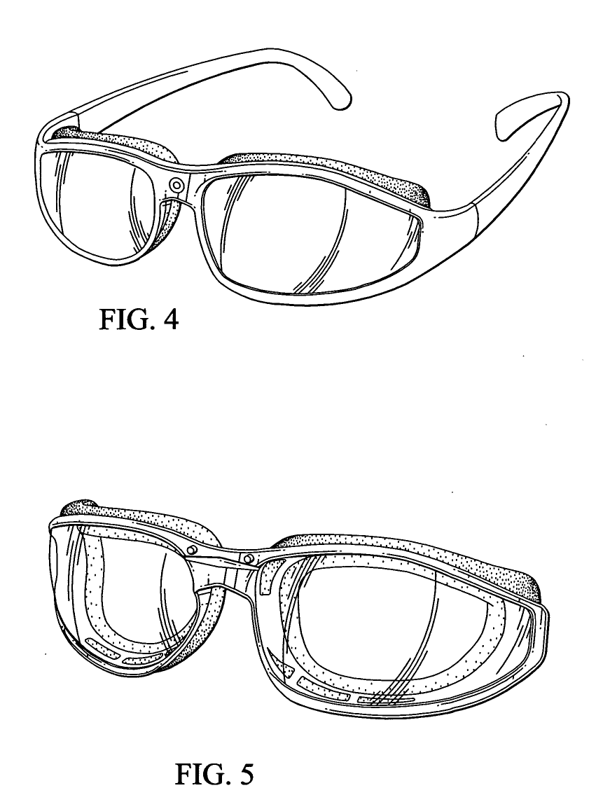

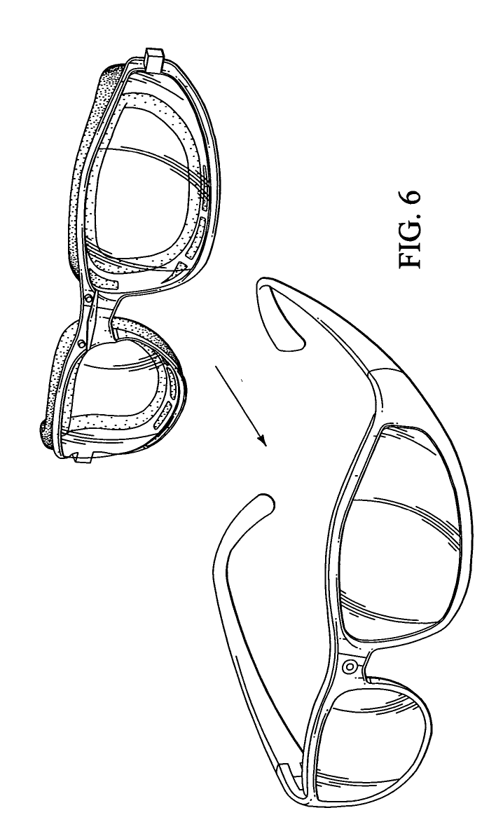

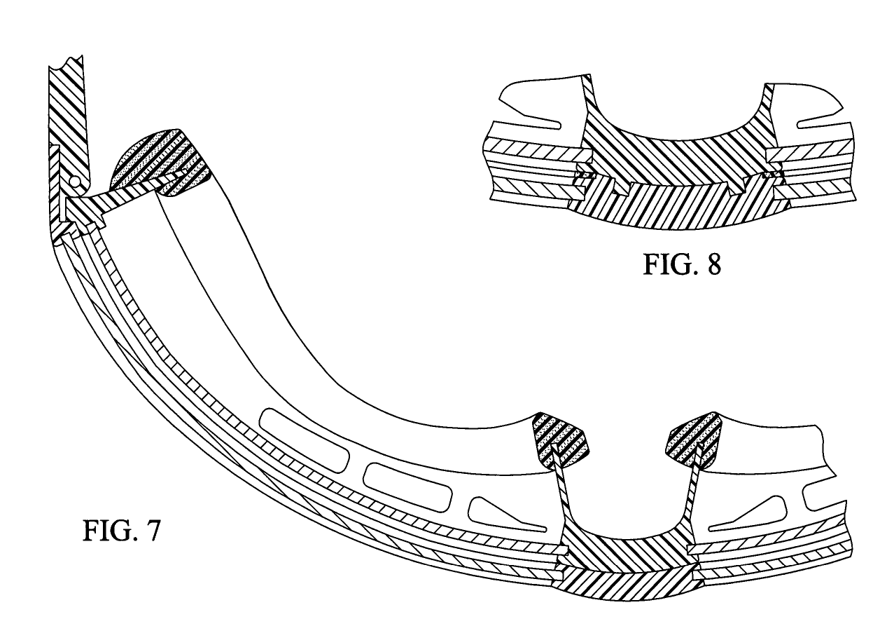

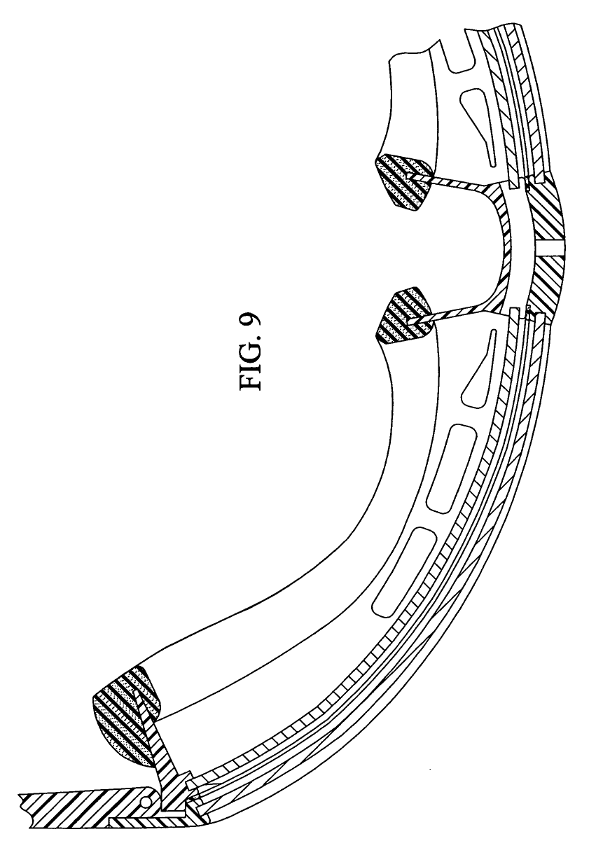

FIGS. 4-9 depict an eyecup constructed in accordance with a second aspect of the present invention. As seen in FIG. 4, in one aspect of the present invention, the frames may be provided with a ram air vent which is constructed to align with a venting channel in the front face of the eyecup. Also, if the eyecup is designed to be removable, the eyecup may include pin-type projections in the front face and tabs at either end (FIG. 6) for aligning and/or maintaining the eyecup within the frames. Other means of mounting and/or attaching the eyecup to the frames are contemplated without departing from the spirit of the invention.

Prior art lenses for use in windless eyewear generally comprise a single, dual layer lens installed in the frames of the glasses. The dual layer lens generally consists of an outer thicker lens material attached or sealed to a thinner rear lens material. The rear lens material is generally an antifogging material. Also, prior art eyecups do not include any additional lenses therein. Such an arrangement limits the full range of alternatives available for windless eyewear. Accordingly, the full range of features and benefits provided by windless eyewear are not being realized in the prior art.

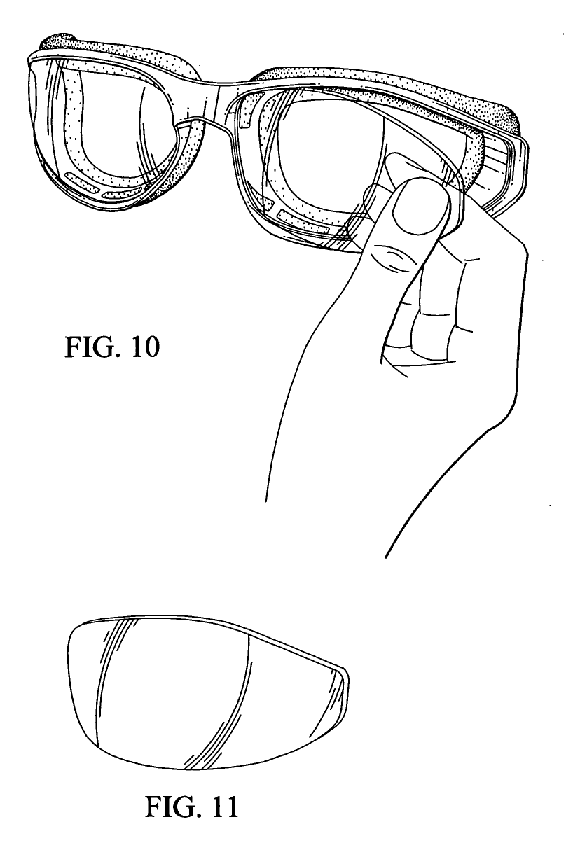

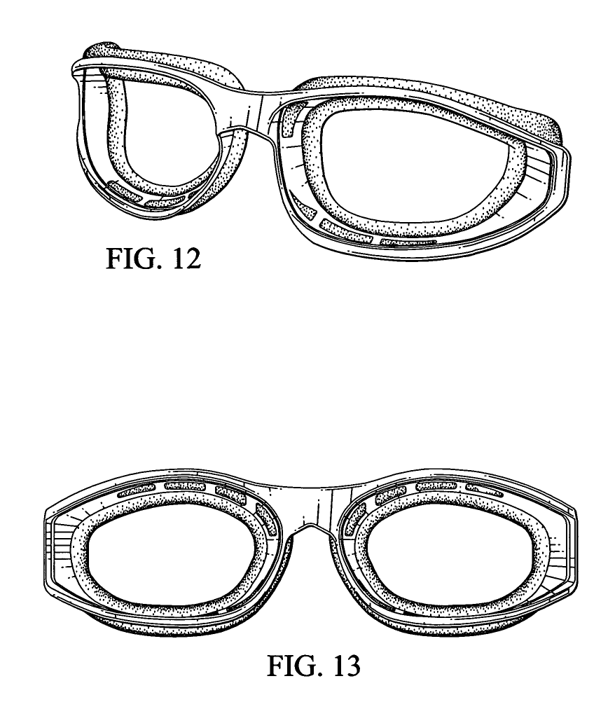

Accordingly, in one aspect of the present invention, as depicted in FIGS. 4-11, the eyecup comprises a lens therein. The lens is generally positioned within a channel formed proximate the front surface of the eyecup. A sealing gasket may also be formed between the lens on the eyecup and the lens in the frames. In a preferred embodiment of the present invention, the lens within the eyecup is a thin 0.5-1.2 mm plano lens to enhance thermal properties while avoiding fogging or a prescription lens for prescription wearers and the lens within the frames is a plano designed to deliver the optical performance required for different functional uses. The particular position of the lens within the eyecup and the frame, and the materials and/or design of the sealing gasket is not critical to the present invention and is generally a matter of application specific design choice. Additionally, the lens in the eyecup may be removable, as depicted in FIGS. 10 and 11.

Including a lens (whether fixed or removable) in the eyecup of the present invention provides for numerous advantageous benefits over the prior art windless eyewear. Specifically, in addition to adding improved comfort by contouring the face more accurately, the addition of an inner lens gives the wearer the flexibility to adapt one pair of eyewear to multiple sports functions. By way of example, with the use of a thin plano inner lens in combination with a normal front lens, the sunglass can be used for extreme conditions like high altitude hiking or skiing, or a polarized lens could be used for driving with a prescription lens, which avoids the need to use separate prescription eyewear or contact lenses.

In another aspect of the present invention, multiple venting designs can be incorporated, thereby offering the user the option to customize the sunglass to the appropriate functional needs of the preferred sport. Specifically, two venting technologies are envisioned, one system called “draft” can be used when only a gentle movement of ventilating air is necessary. This venting system uses the motion of the user to create a vacuum behind the frame to gently draw ventilating air through the eyecup chamber. The other system is called scooped or ram venting where a direct frontal scoop is used to aggressively force a large volume of air through the chamber.

In another aspect of the present invention, the eyecup is designed as a part of an articulating axis thereby allowing the eyecup to seat itself to the wearer's face more completely and comfortably than existing designs.

In another aspect of the present invention, the lower portion of the lens has a darkened segment either in tint or by use of a coating to better protect the wearer, such as for example, a motorcycle user, for typical glare both off the road and the motorcycle surfaces when in use on the road.

In another aspect of the present invention, the temple portion of the eyewear is designed to allow the sunglass to be easily adjusted to a variety of head sizes and allow the user to easily put on and remove the sunglass both with and without a helmet.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between. In particular, this invention should not be construed as being limited to the dimensions, proportions or arrangements disclosed herein.

What is claimed is:

1. An eyecup for use with eyewear, said eyecup comprising a front surface adapted to mate with a frame portion of said eyewear, and a rear contoured surface which is shaped to substantially contact an area of the face of the wearer, said area comprising the bone structure proximate the eyes of the wearer.

2. The eyecup of claim 1, wherein the contour portion comprises foam that conforms to the contour of the bone structure of the face of the wearer.

3. The eyecup of claim 2, wherein the foam comprises an open cell air permeable foam.

4. The eyecup of claim 2, wherein the foam comprises a closed cell foam.

5. The eyecup of claim 1, wherein the contour portion comprises a coating to provide a seal against the face of the wearer.

6. The eyecup of claim 5, wherein the coating comprises semi-rigid material.

7. The eyecup of claim 6, wherein the semi-rigid material comprises silicone.

8. The eyecup of claim 2, wherein the foam comprises two separate pieces.

9. The eyecup of claim 2, wherein the foam comprises one piece.

10. The eyecup of claim 1, further comprising ventilation apertures formed between the front surface and the contour portion.

11. The eyecup of claim 10, wherein the ventilation apertures comprise a filter.

12. The eyecup of claim 11, wherein the filter comprises a foam material.

13. The eyecup of claim 1, wherein the front surface comprises a mounting means which engage with grooves in the frame to secure the eyecup to the frame.

14. The eyecup of claim 1, further comprising a lens mounted therein.

15. The eyecup of claim 14, further comprising a sealing gasket between the lens in the eyecup and a lens mounted in the frame.

16. The eyecup of claim 14, wherein the lens in the frame is a plano lens.

17. The eyecup of claim 14, wherein the lens in the frame is polarized.

18. The eyecup of claim 1, wherein the eyecup is fixedly attached to the eyewear.

19. The eyecup of claim 1, wherein the eyecup is removably attached to the eyewear.
